(19) United States
(12) Patent Application Publication
(10) Pub. No.: US 2012/0183242 A1
(43) Pub. Date: Jul. 19, 2012

(54) SLIDE RAIL ASSEMBLY

(75) Inventors: CHEN-SHENG TANG, Tu-Cheng (TW); SHU-CHEN LIN, Tu-Cheng (TW); HUNG-TING SU, Tu-Cheng (TW)

(73) Assignee: HON HAI PRECISION INDUSTRY CO., LTD., Tu-Cheng (TW)

(21) Appl. No.: 13/086,401

(22) Filed: Apr. 14, 2011

(30) Foreign Application Priority Data
Jan. 19, 2011 (TW) 100101906

(51) Int. Cl. F16C 17/00

(52) U.S. Cl. 384/26

(57) ABSTRACT

A slide rail assembly includes a first slide member, and a second slide member. The first slide member defines an opening. The second slide member forms a cantilevered resilient arm extending forwards. An engaging portion is formed on a distal end of the resilient arm. When the second slide member is received in the first slide member, the engaging portion is pressed by the first slide member to deform the resilient arm away from the first slide member. When the second slide member is slid forwards to be out of the first slide member, the resilient arm is restored to allow the engaging portion to engage with a section of the first slide member bounding a front end of the opening, to prevent the second slide member from sliding out of the first slide member.

### BACKGROUND

1. Technical Field

The present disclosure relates to a slide rail assembly.

2. Description of Related Art

Many slide rail assemblies include at least two slide rails. However, some of those slide rails are apt to slide out of place and even fall away from the assembly and possibly damaged.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawing, all the views are schematic, and like reference numerals designate corresponding parts throughout the several views.

FIG. 1 is an assembled, isometric view of an embodiment of a slide rail assembly.

FIG. 2 is an exploded, isometric view of FIG. 1.

FIG. 3 is similar to FIG. 1, but showing the slide rail assembly in a different state.

FIG. 4 is a partial, cross-sectional view of FIG. 3.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

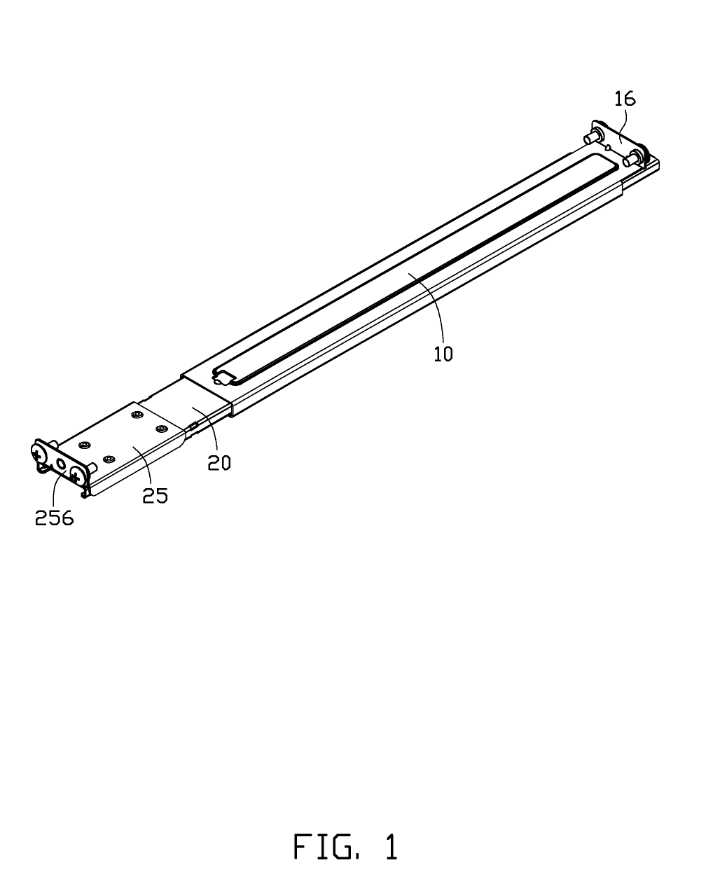

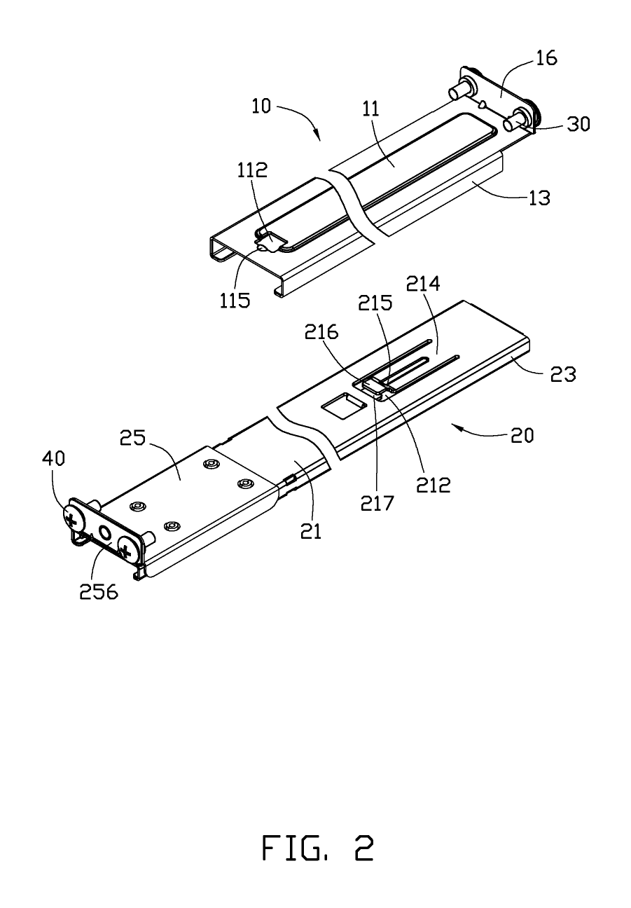

Referring to FIGS. 1 and 2, an embodiment of a slide rail assembly includes a first slide member 10, and a second slide member 20. In this embodiment, the first slide member 10 is a slide rail mounting bracket, and the second slide member 20 is an outer slide rail capable of receiving a middle slide rail and an inner slide rail. In other embodiments, the first slide member 10 is an outer slide rail, and the second slide member 20 is a middle slide rail or an inner slide rail.

The first slide member 10 is substantially C-shaped in cross-section, and includes a first bottom wall 11, and two sidewalls 13 extending inwardly from opposite sides of the first bottom wall 11, respectively. An opening 112 is defined in the first bottom wall 11 adjacent to a front end of the first bottom wall 11. A protrusion 115 protrudes outward from a section of the first bottom wall 11 bounding a front end of the opening 112. An end plate 16 perpendicularly extends outwardly from a rear end of the first bottom wall 11. Two screws 30 are detachably mounted to the end plate 16, to fix the end plate 16 to a post of a rack (not shown).

The second slide member 20 is substantially C-shaped in cross-section, and includes a second bottom wall 21, and two sidewalls 23 extending inwardly from opposite sides of the second bottom wall 21, respectively. A mounting bracket 25 is fixed to a front end of an outer surface of the second bottom wall 21. An end plate 256 perpendicularly extends outward from a front end of the mounting bracket 25. Two screws 40 are detachably mounted to the end plate 256, to fix the end plate 256 to another post of the rack (not shown). A slot 212 is defined in the second bottom wall 21 adjacent to a rear end of the second bottom wall 21. A cantilevered resilient arm 214 extends into the slot 212 from a portion of the second bottom wall 21 bounding a rear end of the slot 212. An engaging portion 216 extends forwards and outwards from a distal end of the resilient arm 214. The engaging portion 216 includes a slanted surface 215 slanting towards the resilient arm 214. A stop plate 217 extends into the slot 212 from a portion of the second bottom wall 21 bounding a front end of the slot 212. A rear section of the stop plate 217 is at an inner side of the engaging portion 216, for blocking the engaging portion 216 when the engaging portion 216 moves inwardly.

In assembly, the second slide member 20 is inserted into the first slide member 10 from the front end of the first slide member 10. The second slide member 20 is slid rearwards along the sidewalls 13 of the first slide member 10. When the slanted surface 215 of the engaging portion 216 abuts against the first bottom wall 11 of the first slide member 10, the resilient arm 214 is deformed inwardly, to allow the engaging portion 216 to move towards the stop plate 217 and be received in the first slide member 10. Thereby, the second slide member 20 can be further slid into the first slide member 10 until the second slide member 20 is stopped by a blocking member (not shown).

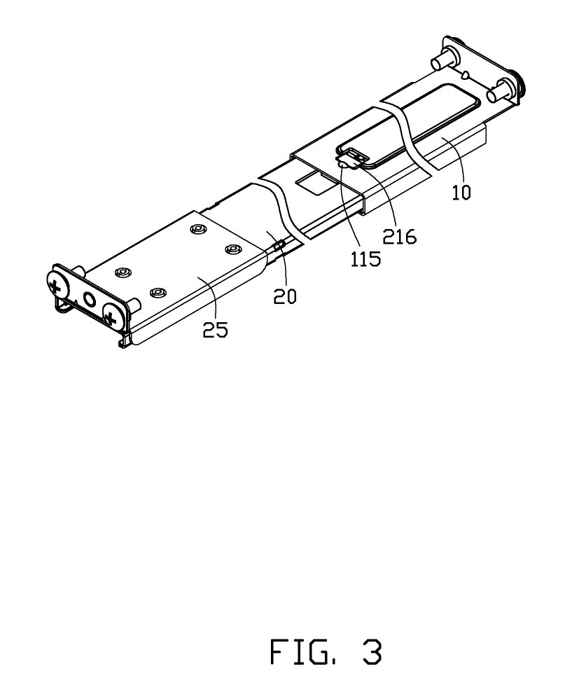

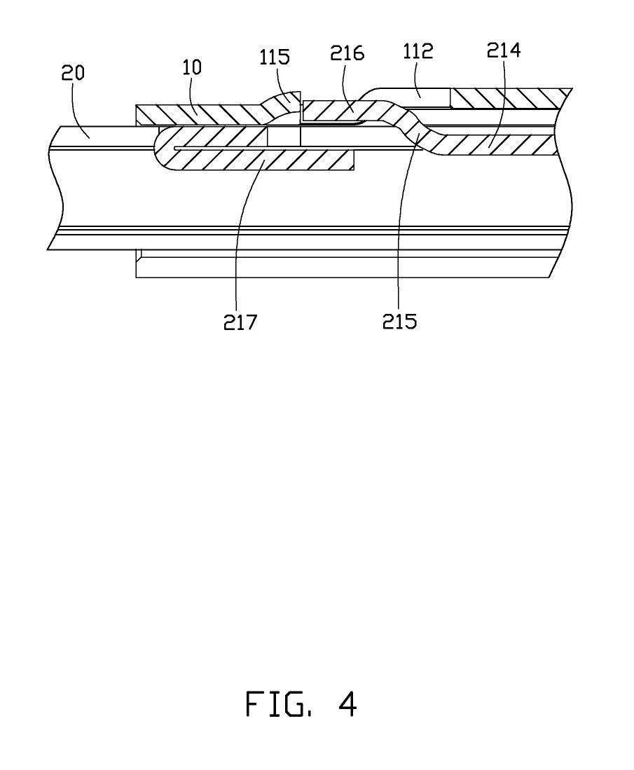

Referring to FIGS. 3 and 4, the second slide member 20 is slid forwards relative to the first slide member 10. When the engaging portion 216 of the second slide member 20 aligns with the opening 112 of the first slide member 10, the resilient arm 214 is restored to allow the engaging portion 216 to engage in the opening 112. The second slide member 20 is further slid, and the engaging portion 216 of the second slide member 20 abuts against the protrusion 115 at the front of the opening 112, to prevent the second slide member 20 from sliding out of the first slide member 10.

When there is a need to detach the second slide member 20 from the first slide member 10, the engaging portion 216 is pressed inwardly to disengage from the protrusion 115 of the first slide member 10. Thereby, the second slide member 20 can be slid out from the first slide member 10.

In other embodiments, the protrusion 115 of the first slide member 10 can be omitted. To prevent the second slide member 20 from sliding out of the first slide member 10, the engaging portion 216 of the second slide member 20 can be arc-shaped or form a slanted engaging surface, to allow the engaging portion 216 to directly abut against the section of the first slide member 10 bounding the front end of the opening 112.

It is to be understood, however, that even though numerous characteristics and advantages of the embodiments have been set forth in the foregoing description, together with details of the structure and function of the embodiments, the disclosure is illustrative only, and changes may be made in details, especially in matters of shape, size, and arrangement of parts within the principles of the embodiments to the full extent indicated by the broad general meaning of the terms in which the appended claims are expressed.

What is claimed is:

1. A slide rail assembly, comprising:
a first slide member comprising a first bottom wall defining an opening therein; and
a second slide member slidably received in the first slide member, the second slide member comprising a second bottom wall defining a slot therein, a cantilevered resilient arm extending into the slot from a portion of the second bottom wall bounding a rear end of the slot, an engaging portion slantingly extending towards the first slide member from a distal end of the resilient arm,
wherein when the second slide member is received in the first slide member, the engaging portion is pressed by the first slide member to deform the resilient arm away from the first slide member; when the second slide member is slid to a position that the engaging portion is exposed by the opening of the first slide member, the resilient arm is restored to allow the engaging portion to engage with a section of the first slide member bounding a front end of the opening.

2. The slide rail assembly of claim 1, wherein the opening is defined in the first bottom wall adjacent to a front end of the first slide member, the slot is defined in the second bottom wall adjacent to a rear end of the second slide member.

3. The slide rail assembly of claim 1, wherein a protrusion protrudes outwardly from a section of the first slide member bounding the front end of the opening, when the second slide member is slid forwards to be out of the first slide member, the resilient arm is restored to allow the engaging portion to engage with the protrusion.

4. The slide rail assembly of claim 1, wherein a stop plate extends into the slot from a portion of the second slide member bounding a front end of the slot, a rear section of the stop plate is at an inner side of the engaging portion.

5. The slide rail assembly of claim 1, wherein the engaging portion comprises a slanted surface towards the resilient arm.

6. A slide rail assembly, comprising:
a first slide member comprising a first bottom wall defining an opening therein; and
a second slide member slidably received in the first slide member, the second slide member comprising a second bottom wall forming a cantilevered resilient arm extending forwards, an engaging portion formed on a distal end of the resilient arm,
wherein when the second slide member is received in the first slide member, the engaging portion is pressed by the first slide member to deform the resilient arm away from the first slide member; when the second slide member is slid forwards to be out of the first slide member, the resilient arm is restored to allow the engaging portion to engage with a section of the first slide member bounding a front end of the opening.

7. The slide rail assembly of claim 6, wherein a protrusion protrudes outwardly from a section of the first slide member bounding the front end of the opening, when the second slide member is slid forwards to be out of the first slide member, the resilient arm is restored to allow the engaging portion to engage with the protrusion.

8. The slide rail assembly of claim 6, wherein the opening is defined in the first bottom wall adjacent to a front end of the first slide member, a slot is defined in the second bottom wall adjacent to a rear end of the second slide member, the resilient arm extends forwards from a portion of the second bottom wall bounding a rear end of the slot.

9. The slide rail assembly of claim 8, wherein a stop plate extends into the slot from a portion of the second slide member bounding a front end of the slot, a rear section of the stop plate is at an inner side of the engaging portion.
